(19) United States
(12) Patent Application Publication
(10) Pub. No.: US 2015/0219124 A1
(43) Pub. Date: Aug. 6, 2015

(54) HYDRAULIC CONTROL DEVICE USING HYDRAULIC ACTUATOR

(71) Applicant: SK INNOVATION CO., LTD., Seoul (KR)

(72) Inventors: Bum Su Kim, Ulsan (KR); Dong Myung Park, Ulsan (KR); Kyu Chai shin, Ulsan (KR)

(21) Appl. No.: 14/350,897

(22) PCT Filed: Oct. 12, 2012
(86) PCT No.: PCT/KR2012/008331

§ 371 Date: Apr. 23, 2015

(30) Foreign Application Priority Data
Oct. 14, 2011 (KR) 10-2011-0105403

(51) Int. Cl. F15B 11/10; F15B 13/042; F15B 13/02; F15B 13/04; F15B 1/027; F15B 1/04

(52) U.S. Cl. CPC F15B 11/10; F15B 1/027; F15B 1/04; F15B 13/021; F15B 13/024; F15B 13/025; F15B 13/0401; F15B 13/0426; F15B 2201/00; F15B 2211/212; F15B 2211/205; F15B 2211/40576; F15B 2211/7051

(57) ABSTRACT

Disclosed herein is a hydraulic control device using a hydraulic actuator. The apparatus includes a hydraulic actuator (110) having a clearance pocket (112), an oil supply line (SL) and an oil discharge line (DL) connected to the hydraulic actuator, a pilot valves (130) provided on each of the oil supply line and the oil discharge line, and a accumulator (140) supplying additional oil to the hydraulic actuator. The hydraulic control device facilitates hydraulic control and makes it possible to control the hydraulic pressure more efficiently and appropriately.

### TECHNICAL FIELD

The present invention relates to a device which can control the capacity of a hydraulic actuator in a continuously variable control manner using a hydraulic device.

### BACKGROUND ART

Generally, hydraulic actuators have a clearance pocket provided on an end of a cylinder. The clearance pocket is opened and closed by means of a handle or a pneumatic actuator so that the volume of the clearance pocket can be varied, whereby the capacity of the cylinder can be controlled. In typical step control, the capacity of the cylinder is adjusted to steps of 50%-75%-100%, and bypass control is used in intermediate ranges between the steps, resulting in high energy consumption. Furthermore, an overload is applied to a compressor, thus causing a problem of damage such as a crack in a welded portion or a reduction in hydraulic pressure. In order to solve the problem, more efficient and appropriate pressure control is required.

### DISCLOSURE

### Technical Problem

Accordingly, the present invention has been made keeping in mind the above problems occurring in the prior art, and an object of the present invention is to provide a hydraulic control device which includes a hydraulic actuator having a clearance pocket, and an accumulator for supplying oil to the hydraulic actuator, thus facilitating hydraulic control, and making it possible to control the hydraulic pressure more efficiently and appropriately.

### Technical Solution

In order to accomplish the above object, in an aspect, the present invention provides a hydraulic control device using a hydraulic actuator, including a hydraulic actuator having a clearance pocket, an oil supply line and an oil discharge line connected to the hydraulic actuator, a pilot valve connected to each of the oil supply line and the oil discharge line, and an accumulator supplying additional oil to the hydraulic actuator.

The oil supply line and the oil discharge line may be connected to the hydraulic actuator.

The oil discharge line may be connected to an upper end of the hydraulic actuator.

The hydraulic control device may further include a reducing valve provided between the oil supply line, the oil discharge line and the pilot valve.

The hydraulic control device may further include a hydraulic valve connected between the accumulator and the hydraulic actuator, the hydraulic valve controlling a pressure of oil.

When a sum of a pressure applied to the hydraulic actuator and a pressure applied to the pilot valve reaches 400 bar, oil of the hydraulic actuator may be discharged.

A cylinder of the hydraulic actuator may be manufactured by forging.

The hydraulic control device may further include an air motor and an air driven pump supplying an oil pressure and oil to the hydraulic actuator.

The hydraulic control device may further include a relief valve and a block valve connected to the accumulator, wherein a degree of pressurization is limited by the block valve, and overpressure is prevented by the relief valve.

Furthermore, oil may be charged into the accumulator at a pressure of 16 bar, and when the pressure of the oil is 16 bar or more, the block valve may be closed.

The relief valve may open at a pressure of 20 bar, thus preventing the accumulator from being over-pressurized.

The accumulator may further include a sight glass provided on the oil discharge line.

The accumulator may have a dual structure.

The accumulator may include two motor-driven hydraulic pumps for supply of oil, wherein one of the two motor-driven hydraulic pumps is continuously operated, and the other motor-driven hydraulic pump is operated when pressure is reduced to a predetermined pressure or less. The accumulator may comprise two high capacity accumulators supplying, in common, required hydraulic oil to ends of the hydraulic actuator

In another aspect, the present invention provides a hydraulic control device including: a plurality of hydraulic pressure control units, each of the hydraulic pressure control units comprising a hydraulic actuator having a clearance pocket, an oil supply line and an oil discharge line connected to the hydraulic actuator, a plurality of pilot valves respectively provided on the oil supply line and the oil discharge line, and an accumulator supplying additional oil to the hydraulic actuator; and a dual oil pump and a large dual accumulator connected to the hydraulic valve units.

The above and other objects, features and advantages of the present invention will be more clearly understood from the following detailed description taken in conjunction with the accompanying drawings.

The terms and words used in the specification and claims must not be limited to typical or dictionary meanings, but must be regarded as concepts selected by the inventor as concepts which best illustrate the present invention, and must be interpreted as having meanings and concepts adapted to the scope and spirit of the present invention to aid in understanding the technology of the present invention.

### Advantageous Effects

The present invention provides a hydraulic control device which includes a hydraulic actuator having a clearance pocket, and an accumulator for supplying oil to the hydraulic actuator. The hydraulic control device facilitates hydraulic control and makes it possible to control the hydraulic pressure more efficiently and appropriately.

### Description of Drawings

FIG. 1 is a schematic block diagram showing a hydraulic control device using a hydraulic actuator according to the present invention;

FIG. 2a is a schematic sectional view showing the hydraulic actuator according to the present invention, and FIG. 2b is a schematic front sectional view showing the hydraulic control according to the present invention;

FIG. 3 is a schematic block diagram showing a hydraulic actuator and a connection unit according to a first embodiment of the hydraulic control device according to the prevent invention;

FIG. 4 is a schematic block diagram showing an accumulator and a connection unit according to an embodiment of the hydraulic control device according to the present invention;

FIG. 5 is a schematic block diagram showing the operation of the accumulator and the connection unit of the hydraulic control device according to the present invention so as to illustrate an oil path;

FIG. 6 is a block diagram showing a portion of the oil path of the hydraulic control device according to the present invention;

FIG. 7 is a schematic block diagram showing a hydraulic actuator and a connection unit according to a second embodiment of the hydraulic control device according to the present invention;

FIG. 8 is a schematic view showing a pilot valve of the hydraulic control device according to the present invention, wherein FIG. 8a illustrates a valve symbol, and FIG. 8b is a sectional view of the valve;

FIG. 9 is a schematic block diagram showing an accumulator and a connection unit according to another embodiment of the hydraulic control device according to the present invention;

FIG. 10 is a schematic block diagram showing a hydraulic actuator and a connection unit according to a third embodiment of the hydraulic control device according to the present invention; and

FIG. 11 is a schematic block diagram showing the hydraulic control device using the hydraulic actuator device according to the second embodiment of the present invention;

### BEST MODE

The objects, features and advantages of the present invention will be more clearly understood from the following detailed description of the preferred embodiments taken in conjunction with the accompanying drawings. Throughout the accompanying drawings, the same reference numerals are used to designate the same or similar components. If in the specification, detailed descriptions of well-known functions or configurations would unnecessarily obfuscate the gist of the present invention, the detailed descriptions will be omitted.

Hereinafter, a hydraulic control device using a hydraulic actuator according to an embodiment of the present invention will be described in detail with reference to the attached drawings.

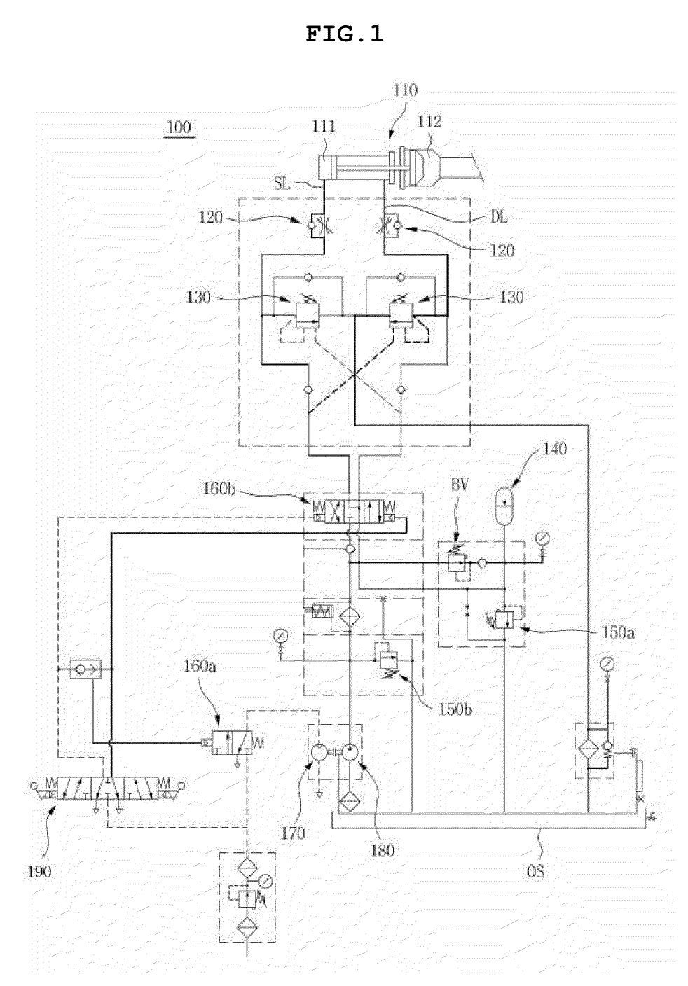

FIG. 1 is a schematic block diagram showing the hydraulic control device using the hydraulic actuator according to the present invention. As shown in FIG. 1, the hydraulic control device 100 includes the hydraulic actuator 110, a reducing valve 120, a pilot valve 130, an accumulator 140, relief valves 150 and 150b, hydraulic valves 160a and 160b, an air motor 170, an air driven pump 180, a solenoid valve 190 and an oil line.

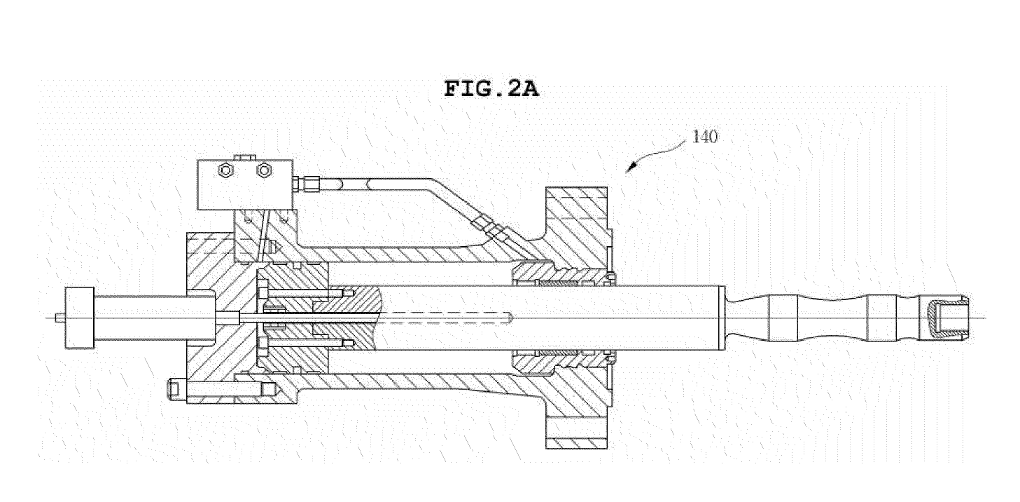

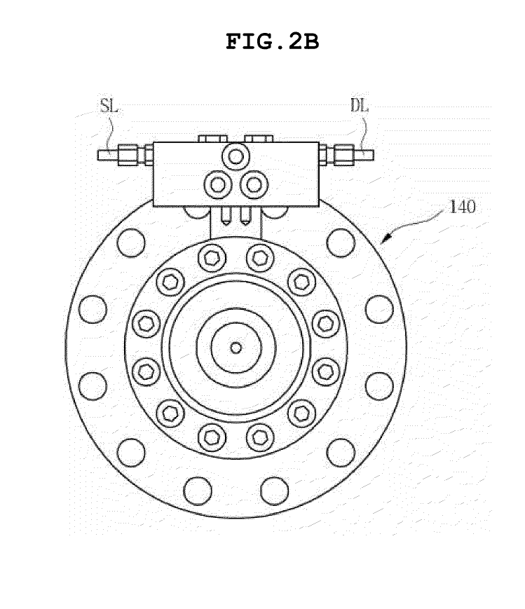

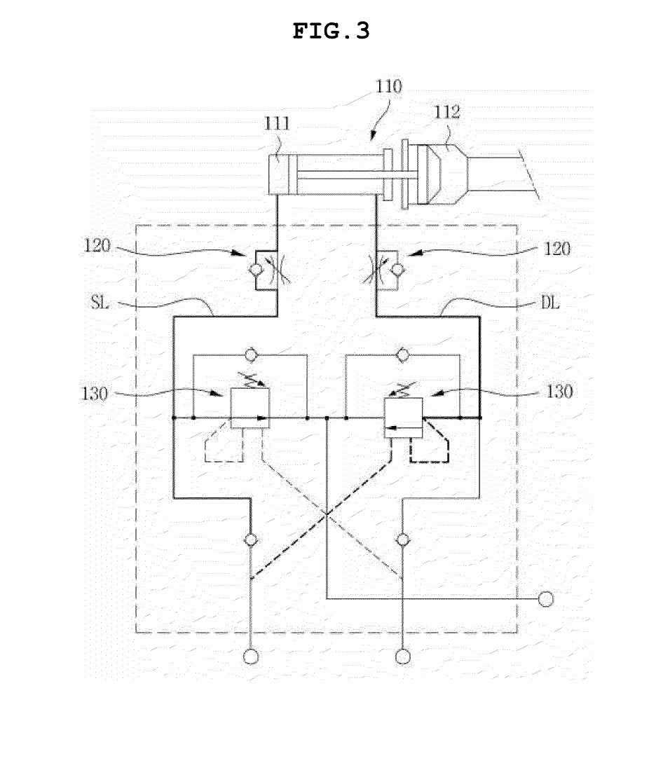

In detail, as shown in FIGS. 2a, 2b and 3, the hydraulic actuator 110 includes a sealing part (not shown), a compression space 111 and a clearance pocket 112. In the sealing part (not shown), a piston rod reciprocates. The compression space 111 is provided to compress oil drawn thereinto, and the clearance pocket 112 is used to control the capacity of the hydraulic actuator.

Constituting the oil line, an oil supply line SL and an oil discharge line DL are connected to the hydraulic actuator 110. The oil discharge line DL is provided above the hydraulic actuator 110. The reason for this is to discharge steam and prevent a phenomenon of the piston being undesirably pushed.

As shown in the drawings, the oil supply line SL and the oil discharge line DL are connected to the hydraulic actuator 110. Particularly, the oil discharge line DL is provided above a cylinder of the hydraulic actuator 110, and steam is discharged to the outside through the oil discharge line DL.

In an embodiment, the cylinder of the hydraulic actuator 110 is manufactured by forging to avoid the problem of cracking resulting from a pressure pulsation in the case when the cylinder is manufactured by casting or welding.

The reducing valve 120 and the pilot valve 130 are provided on each of the oil supply line SL and the oil discharge line DL. If the pilot valve 130 is also used as a check valve, a leakage may be caused. To avoid the above problem, in this embodiment, the pilot valve 130 is used as only the pilot valve without having a function of the check valve. Thereby, the intended lifetime of the pilot valve 130 can be ensured.

In the hydraulic actuator 110 according to the present invention, the oil supply line SL and oil discharge line DL are separately provided. The oil discharge line DL is provided above the hydraulic actuator 110 so that an air bubble can not only be easily removed from the oil discharge line DL, but the reliability of the valves can also be secured because each valve can be directly controlled.

The accumulator 140 refills the hydraulic actuator 110 with oil such that pressure in the actuator is prevented from being reduced below the atmospheric pressure, thus preventing an air bubble from occurring. The relief valve 150a and a block valve BV for prevention of overpressure and interruption of pressure are connected to the accumulator 140. The accumulator 140 may have a dual structure to facilitate the maintenance even when in operation.

In more detail, the accumulator 140 includes two motor-driven hydraulic pumps for supply of oil. One of the two motor-driven hydraulic pumps is continuously operated, and the to other motor-driven hydraulic pump is operated when pressure is reduced to a predetermined pressure or less. The accumulator 140 comprises two high capacity accumulators 140. The accumulators 140 supply, in common, required hydraulic oil to ends of the hydraulic actuator.

The hydraulic valves 160a and 160b control movement of air and oil. The air motor 170 and the air driven pump 180 supply oil to the hydraulic actuator 110 in response to the movement of oil.

The solenoid valve 190 supplies working air in response to variation in the load of the hydraulic actuator.

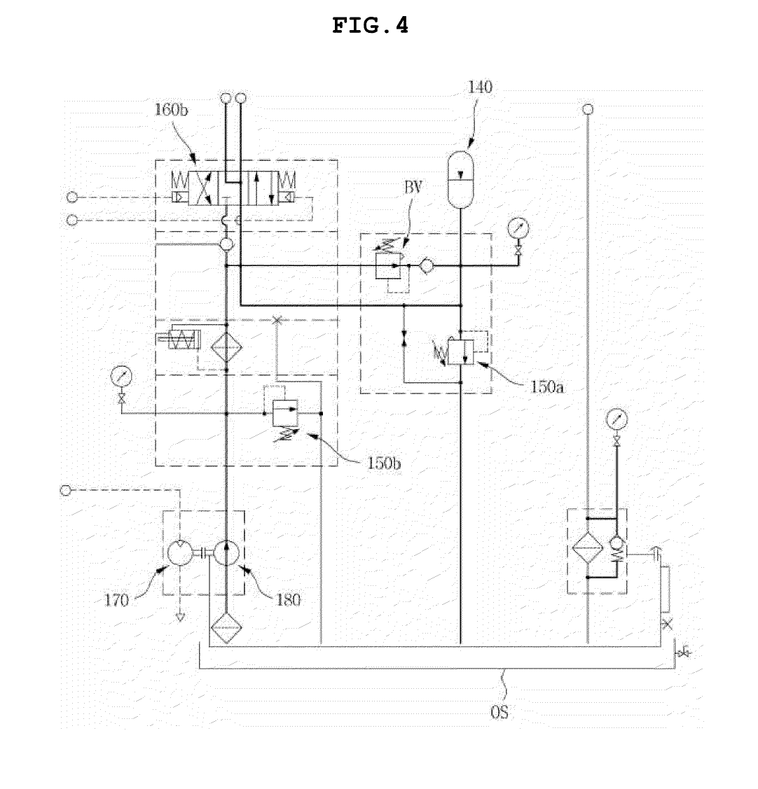

FIG. 4 is a schematic block diagram showing an accumulator and a connection unit according to an embodiment in the hydraulic control device according to the present invention. As shown in the drawing, the accumulator 140 is provided to refill the hydraulic actuator 110 with oil. In detail, when the pressure in the cylinder of the hydraulic actuator 110 is reduced below atmospheric pressure, the accumulator 140 filled with oil refills the hydraulic actuator 110 with oil, thus preventing air or gas from being generated. In an embodiment, the pressure of oil which is charged into the accumulator 140 is 16 bar. Then, the operating time of the air motor 170 can be increased by over-rising of the accumulator 140.

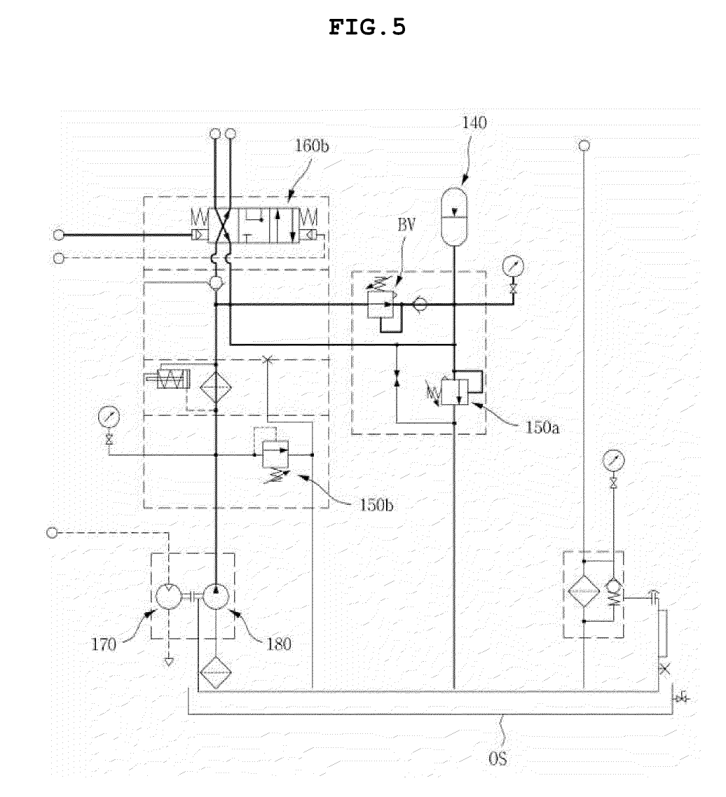

FIG. 5 is a schematic block diagram showing the operation of the accumulator and the connection unit of the hydraulic control device according to the present invention so as to illustrate an oil path. In detail, the accumulator 140 is charged with oil at a pressure of 16 bar by the operation of the air driven pump 180. When oil pressure is 16 bar or more, the block valve BV is closed. The relief valve 150a prevents the accumulator 140 from being overcharged with oil, thus protecting the accumulator 140. Also, oil is supplied to the hydraulic actuator 110 through the oil supply line SL via the hydraulic valve 160b.

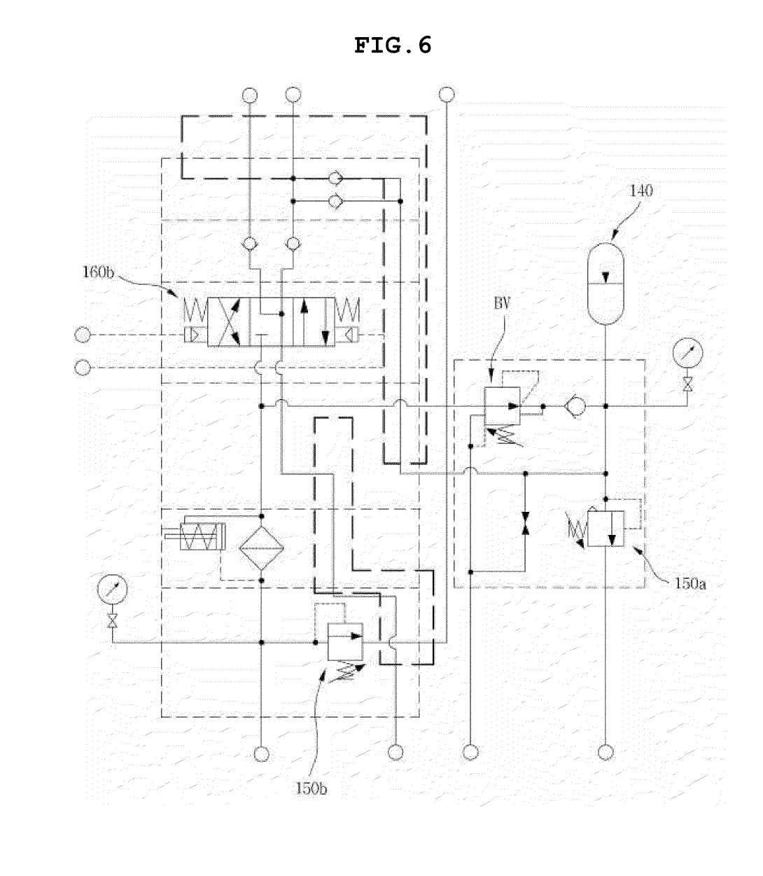

FIG. 6 is a block diagram showing a portion of the oil path of the hydraulic control device according to the present invention. As shown in the dotted line of FIG. 6, the hydraulic actuator 110 is directly connected to the accumulator 140 without passing through a control valve so that the hydraulic actuator 110 can be refilled with oil regardless of a location of the control valve.

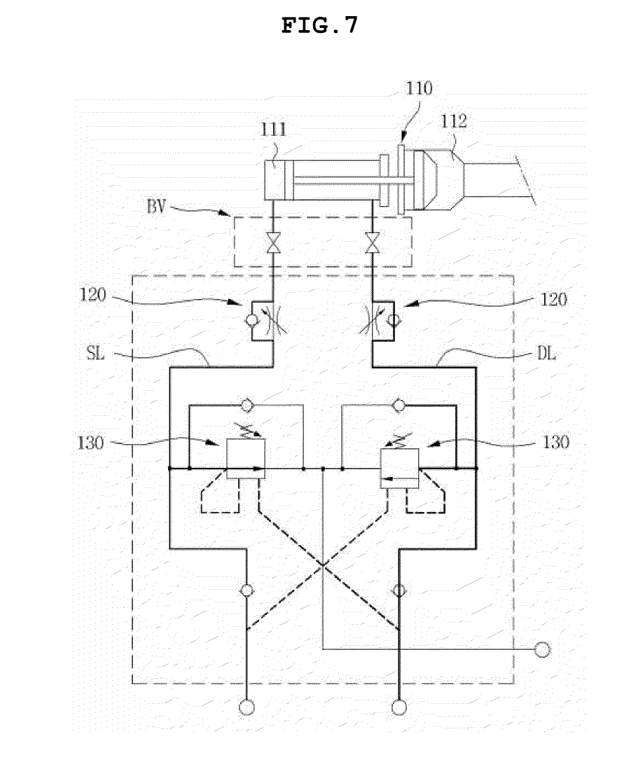

FIG. 7 is a schematic block diagram showing a hydraulic actuator and a connection unit according to a second embodiment of the hydraulic control device according to the present invention. In the hydraulic actuator 110, as shown in FIG. 7, the block valve BV is provided between the hydraulic actuator 110 and the reducing valve 120. The block valve BV makes maintenance of the hydraulic control device 100 possible even when the hydraulic control device 100 is in operation.

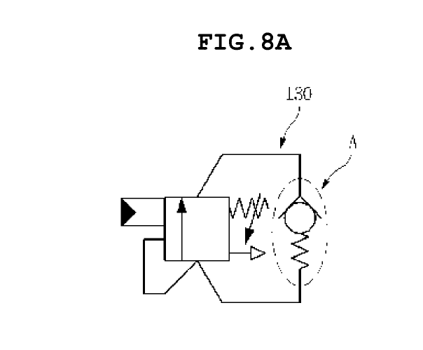

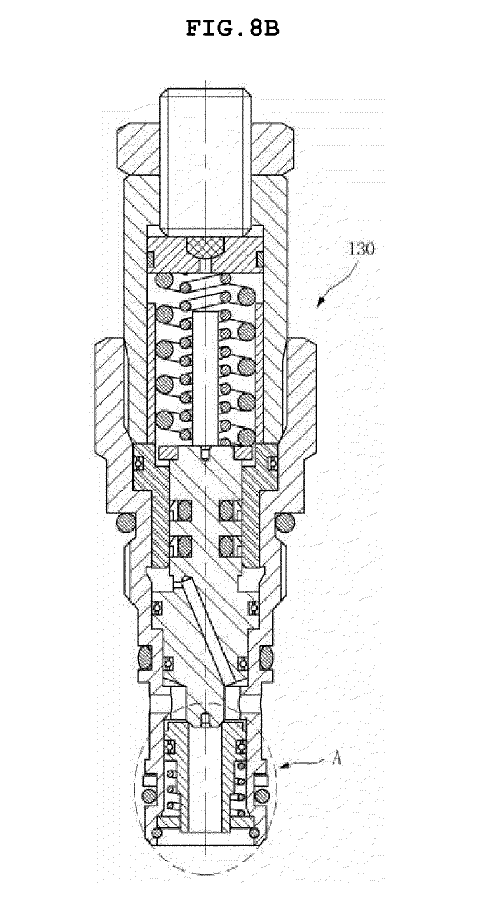

FIG. 8 is a schematic view showing a pilot valve of the hydraulic control device according to the present invention, wherein FIG. 8a illustrates a valve symbol, and FIG. 8b is a sectional view of the valve.

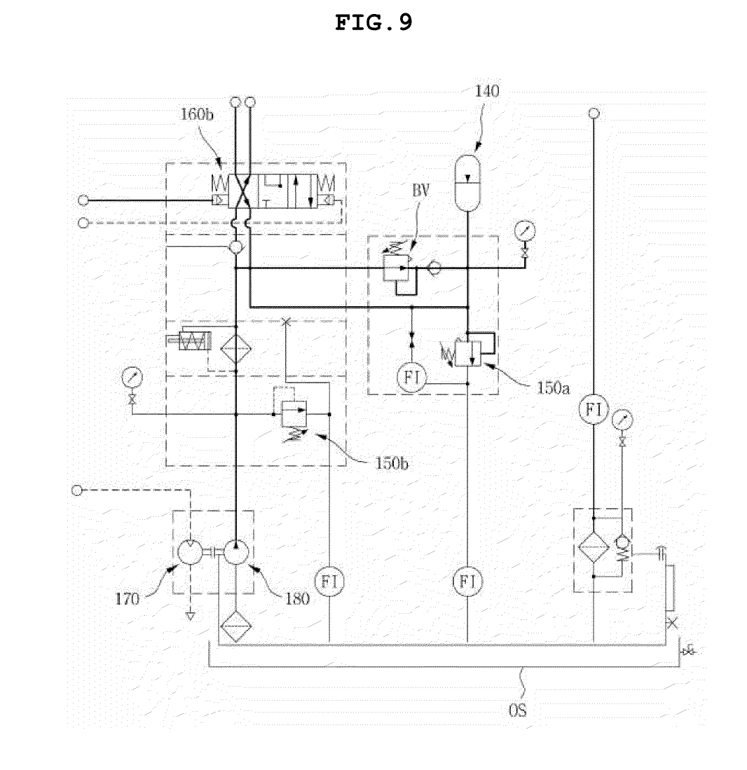

FIG. 9 is a schematic block diagram showing an accumulator and a connection unit according to another embodiment in the hydraulic control device according to the present invention. In the accumulator 140, as shown in drawings, a sight glass FI is provided on the oil discharge line DL so as to enable to monitor whether a point where leakage occurs is present while the hydraulic control device 100 is operated using the hydraulic actuator 110. When a problem occurs, the sight glass FI makes it possible to rapidly find a location when the problem has occurred.

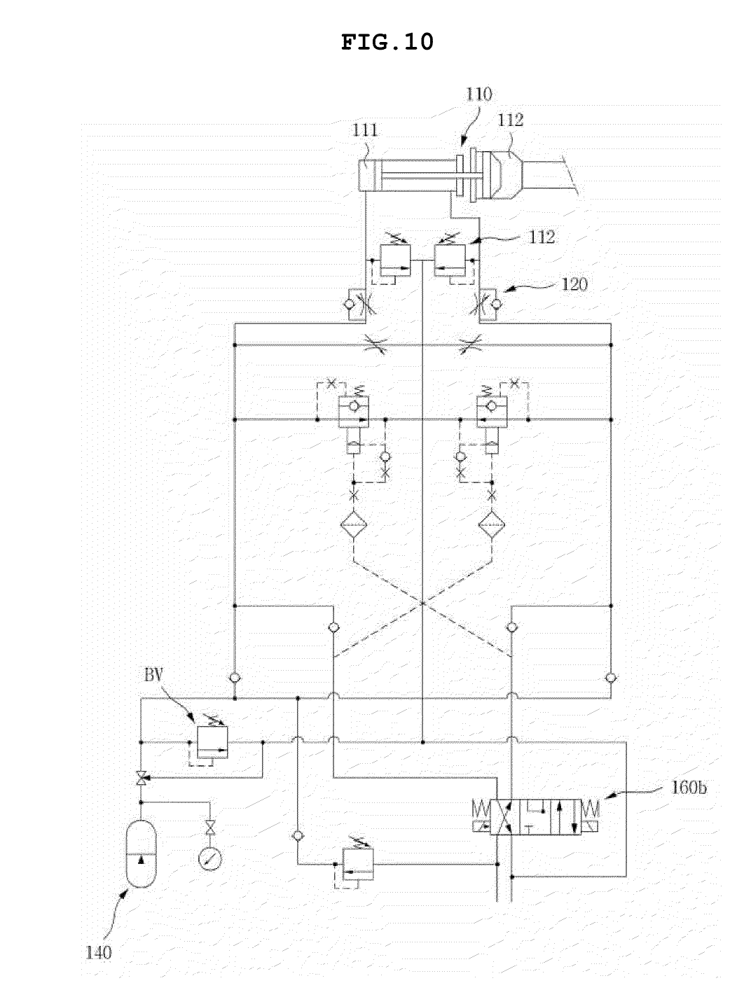

FIG. 10 is a schematic block diagram showing a hydraulic actuator and a connection unit according to a third embodiment in the hydraulic control device according to the present invention. As shown in FIG. 10, to avoid the problem of the pilot valve 130 which is connected to the hydraulic actuator 110, the hydraulic control device has a separate relief function so that the pilot valve 130 can be prevented from losing its function because of a leakage of the relief valve.

The operation of the hydraulic control device using the hydraulic actuator having the above-mentioned construction according to the present invention will be explained below.

If the load of the hydraulic actuator does not vary, working air is interrupted by the solenoid valve 190 and the hydraulic valve 160a. As shown by the left dotted line, if the solenoid valve 190 is operated to the left, working air is supplied to the hydraulic valves 160a and 160b. If the hydraulic valve 160a is operated to the left, air is supplied to the air motor 170. If the air motor 170 operates the air driven pump 180, as shown by the left dotted line, oil pressure is transmitted and, simultaneously, the hydraulic valve 160b is operated to the right. Then, as shown by the left dotted line, oil is supplied.

The oil pressure is applied to the accumulator 140 until the pressure of the accumulator 140 is increased to a predetermined pressure, for example, 16 bar. When the pressure of the accumulator 140 is 16 bar or more, the block valve BV is closed. Here, if the block valve BV breaks down or malfunctions, the relief valve 150a opens at a predetermined pressure, for example, 20 bar, thus preventing the accumulator 140 from being over-pressurized.

Furthermore, the relief valve 150b opens at a pressure of 150 bar so as to prevent the hydraulic control device from being over-pressurized. Oil pressure is applied to the hydraulic actuator 110 through a flexible hose, and the same oil pressure is applied to the valve disposed at the right side, as shown by the left dotted line.

If the sum of pressure directly applied to the hydraulic actuator 110 and pressure applied to the pilot valve 130 reaches a predetermined pressure, for example, 400 bar, the pilot valve 130 opens and discharges oil that has been in the right side of the hydraulic actuator 110. A ratio of the pressure applied to the pilot value 130 along the left dotted line and the pressure applied thereto along the right dotted line is 4.5:1.

Also, if pressure applied to the portion designated by the right dotted line reaches 15 bar or pressure applied to the portion designated by the left dotted line reaches 85 bar, the pilot valve 130 opens.

When the pilot valve 130 opens, as shown in the red line, oil is reliably discharged to an oil sump OS from the hydraulic actuator 110 until reaching a new setting position.

When the air motor 170 is stopped, the pressure of the hydraulic control device 100 is reduced to the pressure of the accumulator 140. The pressure of the hydraulic actuator 110 is maintained in a range from 70 bar to 80 bar and then gradually reduced to the pressure of hydraulic control device 100 by a leakage of a non-return valve.

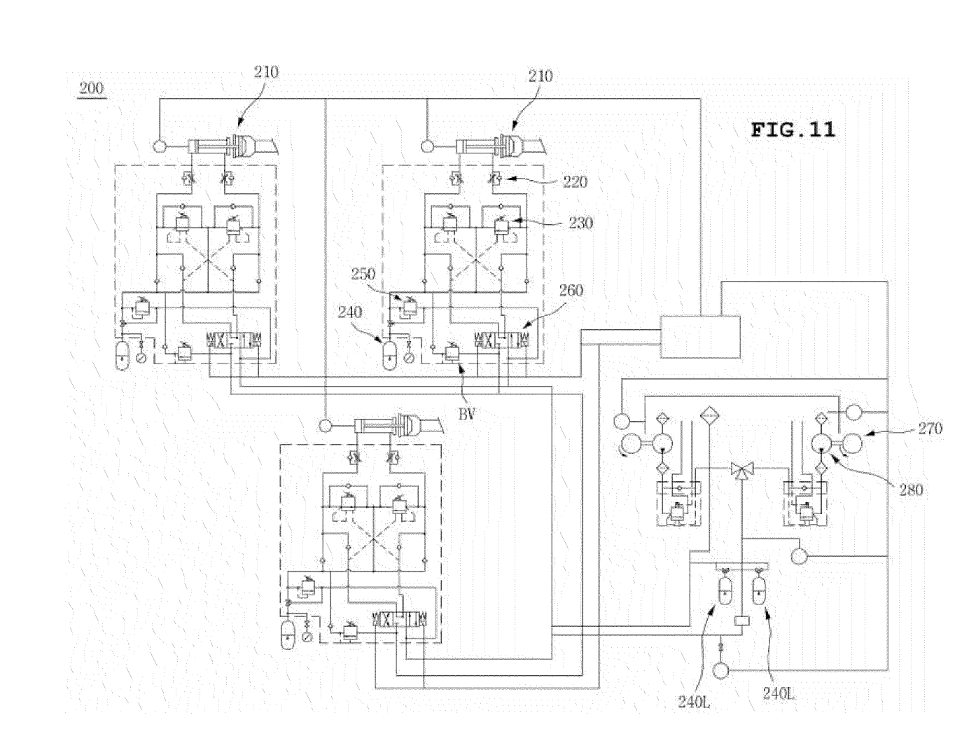

FIG. 11 is a schematic block diagram showing the hydraulic control device using the hydraulic actuator device according to the second embodiment of the present invention. As shown in FIG. 11, a hydraulic control device 200 includes a plurality of hydraulic actuator modules. Each of the hydraulic actuator modules includes a hydraulic actuator 210, a pilot valve 220, an accumulator 240 and a hydraulic valve 260. The hydraulic control device 200 is operated in such a way that, as needed, oil is supplied to the hydraulic actuator modules by a dual oil pump 270 and a large dual accumulator 240L.

Although the preferred embodiments of the present invention have been disclosed for illustrative purposes, those skilled in the art will appreciate that various modifications, additions and substitutions are possible, without departing from the scope and spirit of the invention as disclosed in the accompanying claims

Accordingly, any and all modifications, variations or equivalent arrangements should be considered to be within the scope of the invention, and the detailed scope of the invention will be disclosed by the accompanying claims.

### DESCRIPTION OF THE ELEMENTS IN THE DRAWINGS

100: hydraulic control device 110: hydraulic actuator

120: reducing valve 130: pilot valve

140: accumulator 150a, 150b: relief valve

160a, 160b: hydraulic valve 170: air motor

180: air driven pump 190: solenoid valve

1. A hydraulic control device using a hydraulic actuator, comprising:
a hydraulic actuator having a clearance pocket;
an oil supply line and an oil discharge line connected to the hydraulic actuator;
a pilot valve connected to each of the oil supply line and the oil discharge line; and
an accumulator supplying additional oil to the hydraulic actuator.

2. The hydraulic control device using a hydraulic actuator of claim 1, wherein the oil supply line and the oil discharge line are connected to the hydraulic actuator.

3. The hydraulic control device using a hydraulic actuator of claim 1, wherein the oil discharge line is connected to an upper end of the hydraulic actuator.

4. The hydraulic control device using a hydraulic actuator of claim 1, further comprising
a reducing valve provided between the oil supply line, the oil discharge line and the pilot valve.

5. The hydraulic control device using a hydraulic actuator of claim 1, further comprising
a hydraulic valve connected between the accumulator and the hydraulic actuator, the hydraulic valve controlling a pressure of oil.

6. The hydraulic control device using a hydraulic actuator of claim 1, wherein when a sum of a pressure applied to the hydraulic actuator and a pressure applied to the pilot valve reaches 400 bar, oil of the hydraulic actuator is discharged.

7. The hydraulic control device using a hydraulic actuator of claim 1, wherein a cylinder of the hydraulic actuator is manufactured by forging.

8. The hydraulic control device using a hydraulic actuator of claim 1, further comprising
an air motor and an air driven pump supplying an oil pressure and oil to the hydraulic actuator.

9. The hydraulic control device using a hydraulic actuator of claim 1, further comprising
a relief valve and a block valve connected to the accumulator, wherein a degree of pressurization is limited by the block valve, and overpressure is prevented by the relief valve.

10. The hydraulic control device using a hydraulic actuator of claim 9, wherein oil is charged into the accumulator at a pressure of 16 bar, and when the pressure of the oil is 16 bar or more, the block valve is closed.

11. The hydraulic control device using a hydraulic actuator of claim 9, wherein the relief valve opens at a pressure of 20 bar, thus preventing the accumulator from being over-pressurized.

12. The hydraulic control device using a hydraulic actuator of claim 1, wherein the accumulator further comprises a sight glass provided on the oil discharge line.

13. The hydraulic control device using a hydraulic actuator of claim 1, wherein the accumulator has a dual structure.

14. The hydraulic control device using a hydraulic actuator of claim 1, wherein the accumulator comprises two motor-driven hydraulic pumps for supply of oil, wherein one of the two motor-driven hydraulic pumps is continuously operated, and the other motor-driven hydraulic pump is operated when pressure is reduced to a predetermined pressure or less, and
the accumulator comprises two high capacity accumulators supplying, in common, required hydraulic oil to ends of the hydraulic actuator.

15. A hydraulic control device using a hydraulic actuator comprising:
a plurality of hydraulic pressure control units, each of the hydraulic pressure control units comprising a hydraulic actuator having a clearance pocket, an oil supply line and an oil discharge line connected to the hydraulic actuator, a plurality of pilot valves respectively provided on the oil supply line and the oil discharge line, and an accumulator supplying additional oil to the hydraulic actuator; and
